(19) United States
(12) Patent Application Publication
(10) Pub. No.: US 2008/0253378 A1
(43) Pub. Date: Oct. 16, 2008

(54) Delivery of Peak Performance Services

(75) Inventor: Lewis A. Curry, Missoula, MT (US)

Correspondence Address: MERCHANT & GOULD PC, P.O. BOX 2903, MINNEAPOLIS, MN, 55402-0903, US

(73) Assignee: HOPE SOLUTIONS INTERNATIONAL, LLC, Missoula, MT (US)

(21) Appl. No.: 11/735,617

(22) Filed: Apr. 16, 2007

(51) Int. Cl. H04L 12/26

(52) U.S. Cl. 370/395.4

(57) ABSTRACT

Systems for providing peak performance services include a peak performance service provider that provides peak performance services to enhance individuals' performances in sports, and at least one institution that purchases peak performance services from the peak performance service provider for individuals associated with the institution. The peak performance provider makes the peak performance services available to the individuals associated with the institution for a reduced fee or for free, and the peak performance provider provides peak performance services to individuals not associated with the institution for regular fees. Methods for providing peak performance services to enhance individuals' performances in sports include marketing the peak performance services to institutions, allowing an institution to purchase the peak performance services, and providing the peak performance services to an individual associated with the institution.

### BACKGROUND

Athletics have become an important part of our culture. Sporting functions, from individual competitions to team events, pervade non-professional arenas such as educational institutions, as well as professional teams usually associated with a particular municipality. As the importance of sports grows, the pressure to perform at higher and higher levels also increases.

Applied sports psychology seeks to educate coaches, athletes, and parents of athletes with a goal of obtaining optimal performance. Peak performance services are offered to help the athlete to improve his or her performance. Such services can include both mental and physical conditioning. Typically, peak performance services are only available to top athletes with the financial resources to pay for such services. For example, professional sports teams can retain one or more peak performance service providers to help improve the teams' athletes' performances.

Optimal performance is becoming more important for younger athletes as well. For example, athletes in junior high school and high school spend many hours preparing for and participating in sporting events. Athletics also play a large role in the collegiate experience, and such athletes are expected to perform at a very high level of aptitude. Even non-competitive athletes, such as those that participate in sports for fun and/or exercise, look to increase performance levels. However, such non-professional athletes typically do not have the resources to obtain peak performance services that may help the athletes to increase their performance levels.

Improvements in the delivery of peak performance services are therefore desirable.

### SUMMARY

Example delivery systems and methods for peak performance services are described herein.

In one aspect, a system for providing peak performance services includes a peak performance service provider that provides peak performance services to enhance individuals' performances in sports, and at least one institution that purchases peak performance services from the peak performance service provider for individuals associated with the institution. The peak performance provider makes the peak performance services available to the individuals associated with the institution for a reduced fee or for free, and the peak performance provider provides peak performance services to individuals not associated with the institution for regular fees.

In another aspect, a method for providing peak performance services to enhance individuals' performances in sports includes marketing the peak performance services to institutions, allowing an institution to purchase the peak performance services, and providing the peak performance services to an individual associated with the institution.

In yet another aspect, the peak performance services include personal consultations, hard copy resources, and/or electronic resources available over the Internet.

### DESCRIPTION OF THE DRAWINGS

Reference is now made to the accompanying drawings, which are not necessarily drawn to scale.

FIG. 1 shows an example system for providing peak performance services to individuals associated with a plurality of institutions.

FIG. 2 shows an example system for providing peak performance services to an individual.

FIG. 3 shows an example method for providing peak performance services to individuals associated with an institution.

FIG. 4 shows another example method for providing peak performance services to athletes associated with a school district.

FIG. 5 shows an example method for marketing peak performance services to institutions.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example systems and methods described herein relate to the delivery of peak performance services to individuals. In example embodiments, an institution purchases peak performance services from a peak performance service provider. Individuals associated with the institution can then receive the peak performance services from the peak performance service provider for a reduced rate, or for free.

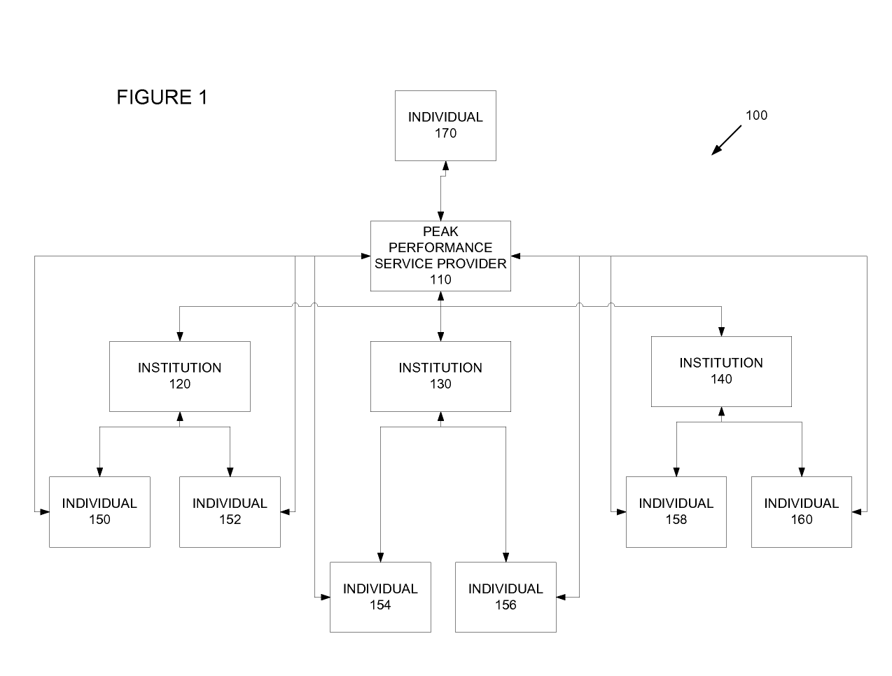

Referring now to FIG. 1, an example system 100 is shown including a peak performance service provider 110, a plurality of institutions 120, 130, 140, and a plurality of individuals 150, 152, 154, 156, 158, 160, 170. Generally, the institutions 120, 130, 140 purchase peak performance services from the peak performance service provider 110, so that the individuals 150, 152, 154, 156, 158, 160 associated respectively with the institutions 120, 130, 140 can obtain the peak performance services.

In the examples described herein, the peak performance service provider 110 includes one or more organizations with one or more individuals that are trained to counsel athletes, coaches (including sports administrators), and parents to enhance athletes' performances. In one example, the peak performance service provider 110 includes at least one individual that is certified by the Association for the Advancement of Applied Sport Psychology (“AAASP”) to provide peak performance services to athletes, coaches, and parents.

In one example, the peak performance service provider 110 is a single individual. In other examples, the peak performance service provider 110 is a group of individuals that together provide peak performance services.

In yet other examples, the peak performance service provider 110 is a centralized service provider with one or more branch offices located at remote locations. For example, in one embodiment, the peak performance service provider 110 contracts with one or more independent contractors to provide peak performance services at different geographical locations. In another embodiment, the peak performance service provider 110 hires employees to provide peak performance services in different locations. In yet other embodiments, the peak performance service provider 110 licenses franchisees that are located at remote geographic locations to provide peak performance services at those locations. In one example, the franchisees are granted exclusive rights to provide the peak performance services a particular geographic area. The franchisees can be certified by the franchiser to provide peak performance services. For example, the franchisees can be required to undergo a training and evaluation process before being allowed to offer the peak performance services. Other configurations are possible.

Generally, the peak performance services are configured to enhance and optimize an athlete's performance. The peak performance services can include products and services in the area of optimal performance awareness and enhancement. These products and services generally fall under the heading of Psychology Skills Training (“PST”), Self-Regulation, and/or Life Coaching. These approaches to peak performance and life skills help individuals and teams apply techniques and strategies designed to enhance mental skills that facilitate optimal performance in competitive environments, and affect a positive approach to gaining confidence, a competitive edge, and greater enjoyment in meeting life's challenges.

The institutions 120, 130, 140 purchase the peak performance services from the peak performance service provider 110. In example embodiments, an institution can be an educational institution such as a junior high school, a high school, or a college. An institution can also be a municipality such as a school district, a city, or a county. In other embodiments, an institution is a local or national sports association, or a sporting organization for amateur athletics such as a youth sports league. In yet other embodiments, an institution includes other organizations such a health club, a minor league sports team, or another organization for non-professional athletes.

The institutions 120, 130, 140 purchase the peak performance services from the peak performance service provider 110 so that the individuals 150, 152, 154, 156, 158, 160 associated with the institutions 120, 130, 140 can receive the peak performance services at a discounted rate or for free. In the examples shown, various individuals are considered to be associated with the institutions 120, 130, 140. For example, members of the institution, as well as the families of the members, can be associated with the institution and therefore qualify for services at a discounted rate or for free.

For example, in one embodiment, the institution 120 is a high school, and individuals 150, 152 are athletes that attend and play sports at the high school, administrators and coaches of teams at the high school, and/or parents of the athletes at the high school. By virtue of the agreement between the high school and the peak performance provider 100, the individuals 150, 152 (i.e., athletes, administrators/coaches, and parents) can obtain peak performance services at a reduced rate or for free from the peak performance service provider 110. In some embodiments, other members of the nuclear family of the athletes and coaches of the high school (e.g., siblings) are also eligible for the services as well.

The individual 170 is not associated with any of the institutions 120, 130, 140. In the example shown, the individual 170 can also receive peak performance services from the peak performance service provider 110. However, the individual 170 does not receive reduced rates or free services. Instead, the individual 170 must pay regular rates to receive such services because the individual 170 is not associated with any of the institutions 120, 130, 140. In other embodiments, the peak performance services provided to the individual 170 are limited (e.g., in-person consultations are limited or not offered) as compared to the services provided to individuals that are associated with the institutions 120, 130, 140. In yet other alternative embodiments, the individual 170 cannot purchase the peak performance services. Instead, the peak performance service provider 110 only provides the peak performance services to individuals associated with one or more of the institutions 120, 130, 140. Other configurations are possible.

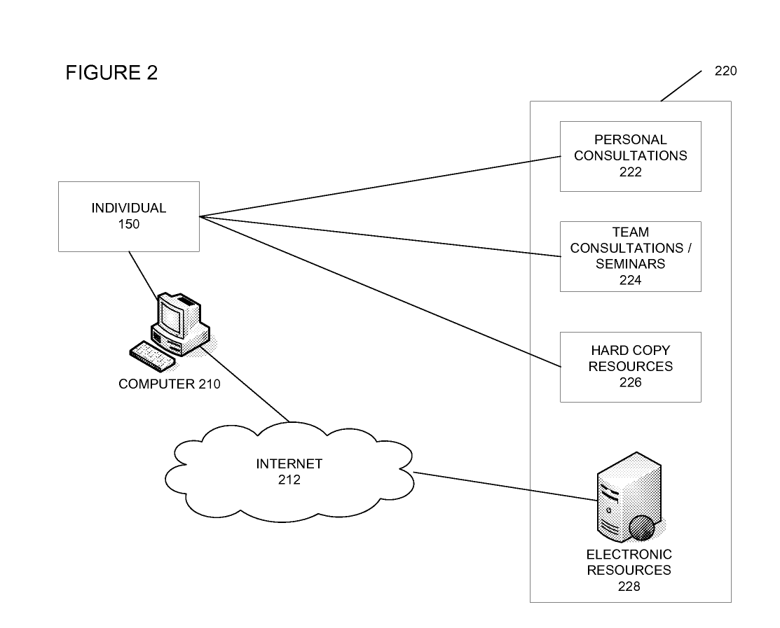

Referring now to FIG. 2, the individual 150 is shown, as well as peak performance services 220. The individual 150 is associated with the institution 120 that has purchased the peak performance services. In example embodiments, the individual 150 can be an athlete, a coach, a sports administrator, or a parent of an athlete. In example embodiments, the athletes are of at least of a certain age, such as fourteen years old, although athletes of other ages can also be provided services. In example embodiments, the athletes are amateur athletes, although other configurations are possible.

Because the individual 150 is associated with the institution 120, the individual 150 can receive the peak performance services 220 from the peak performance service provider 110 for a reduced rate or for free, depending on the arrangement between the institution 120 and the peak performance service provider 110.

The peak performance services 220 can include one or more of the following. In the example shown, the peak performance services 220 include personal consultations 222 with members of the peak performance provider. For example, the personal consultations 222 can be one-on-one meetings between the individual 150 and a consultant of the peak performance service provider that is certified by the AAASP. In examples, the personal consultations 222 can be done in person, over the telephone, or over the Internet by email or web chat.

The peak performance services 220 also include team consultations or seminars 224. The team consultations 224 involve presentations, courses, or seminars that are offered by the peak performance provider to an entire sports team or organization. For example, the peak performance provider can provide one or more presentations to an entire college team relating to enhancement of athletic performance.

The peak performance services 220 can also include hard copy resources 226. The hard copy resources 226 include one or more materials that provide information related to enhancing athletic performance. In one example, the hard copy resources 226 include a manual with a multi-step approach to enhancing athletic performance. The multi-step approach includes resources and exercises designed to enhance peak performance, team productivity, and leadership.

The peak performance services 220 can also include electronic resources 228 that are provided over a network such as Internet 212. For example, in one embodiment, the electronic resources 228 are one or more web sites that include information about peak performance services. The individual 150 can access the electronic resources 228 using a computer 210 via the Internet 212. In one embodiment, the individual 150 logs onto the web site hosted on one or more servers associated with the electronic resources 228 using a browser running on the computer 210. The individual 150 can use the web site to research peak performance issues, and to interact with consultants using, for example, email or web chat technologies. In example embodiments, the electronic resources 228 can be used to supplement and/or replace the hard copy resources 226.

The peak performance services 220 can be modified or tailored depending on the characteristics of the institution 110 or the individual 150. For example, in one embodiment, the hard copy resources 226 are modified based on the age of the individual 150, by including an elementary volume for athletes in high school, and a more advanced volume for college athletes. Similarly, the electronic resources 228 can be modified depending on the age of the individual 150, such as by providing different web sites with different content for high school versus college athletes. In addition, the peak performance services content presented to the individual 150 can be tailored based on the status of the individual 150. For example, the content provided to a student athlete can be different from the content provided to a coach of student athletes.

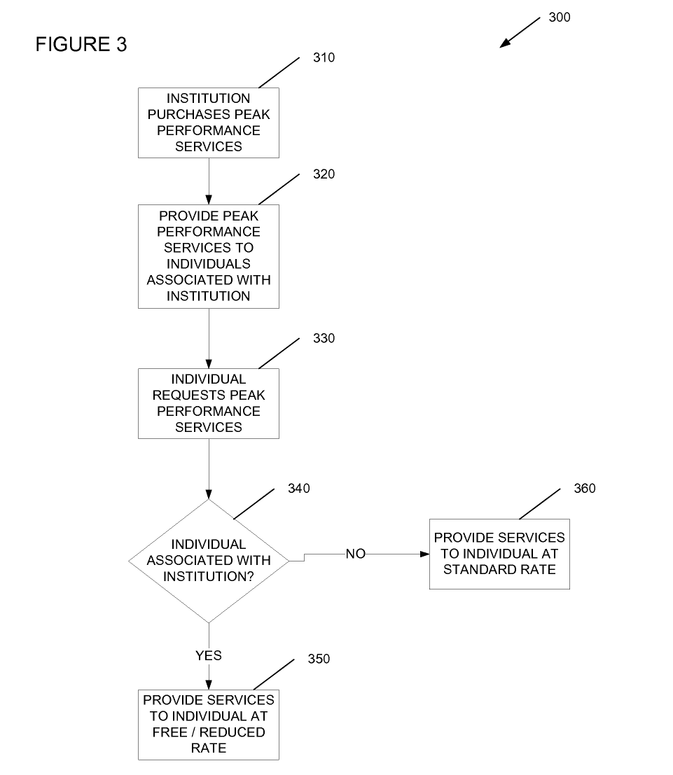

Referring now to FIG. 3, an example method 300 is shown for providing peak performance services. At an operation 310, the institution purchases peak performance services from the peak performance service provider. Next, at an operation 320, the peak performance service provider makes peak performance services (e.g., one or more of the services 220 described above) available to the individuals associated with the institution. Next, at an operation 330, an individual requests peak performance services from the peak performance service provider.

At operation an 340, a determination is made as to whether or not the individual is associated with the institution that has purchased peak performance services from the peak performance service provider. If it is determined that the individual is associated with the institution, control is passed to an operation 350, and the peak performance services are provided to the individual at a reduced rate or for free, depending on the arrangement between the institution and the peak performance service provider. Alternatively, if it is determined at the operation 340 that the individual is not associated with the institution, control is passed to an operation 360, and the services are provided to the individual at a standard rate. In an alternative embodiment, the services provided to the individual at the operation 360 are more limited than those provided to the individual at the operation 350.

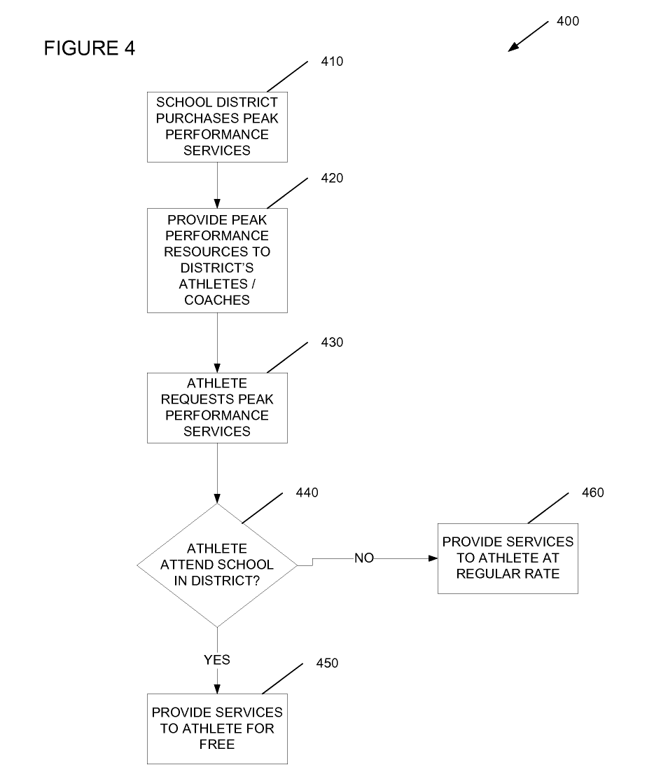

For example, referring now to FIG. 4, another example method 400 is shown for providing peak performance services. For the method 400, the institution is a school district, and the individual is an athlete. Beginning at an operation 410, the school district purchases peak performance services from the peak performance service provider. Next, at an operation 420, the peak performance service provider makes peak performance services available to individuals associated with the school district. At an operation 430, an athlete requests peak performance services from the peak performance service provider.

At an operation 440, a determination is made as to whether or not the athlete attends a school within the school district. If the athlete does attend a school in the school district, the peak performance services are provided to the athlete at a reduce rate, or for free at an operation 450. Alternatively, if the athlete does not attend a school in the school district, control is passed from the operation 440 to an operation 460, and peak performance services are provided to the athlete at a rate that is different from that of the rate provided to athletes that attend a school in the school district, such as at an increased regular rate.

In example embodiments, one or more administrators at each school in the school district, such as the principal, athletic director, or coaches, are given a code that identifies the school. This code is used by the athletes when the athletes sign up for the peak performance services so that the athletes are provided the services at the reduced rate, or for no cost. In some examples, the administrator can also share the code with other individuals associated with the school, such as friends, boosters, alumni, or other supporters, so that these individuals can also use the code to receive peak performance services at a reduced rate. In addition, the school can receive incentives (e.g., reduced costs for the contract between the school and the peak performance provider, increased services, etc.) from the peak performance service provider depending on the number of individuals that sign up for the peak performance services using the code.

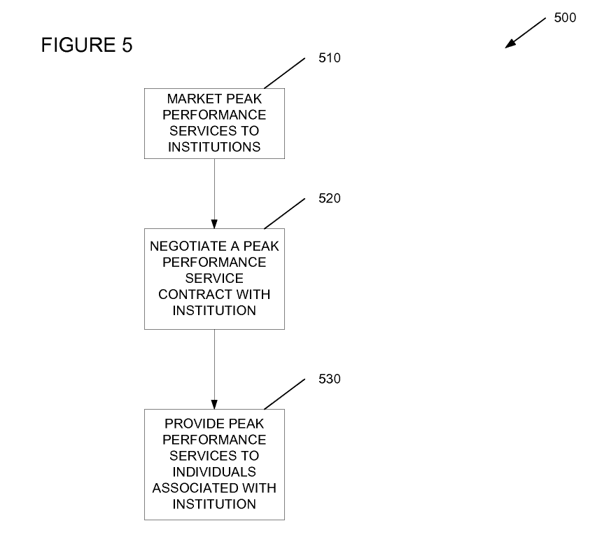

Referring now to FIG. 5, an example method 500 is shown for marketing peak performance services to institutions. Initially, at an operation 510, the peak performance service provider markets the peak performance services to institutions. Next, at an operation 520, the institutions negotiate a peak performance service contract with the peak performance service provider. Assuming a satisfactory agreement is reached, control is then passed to an operation 530, and the peak performance services are made available to individuals associated with the institution.

For example, assume that the institution is a basketball league associated with the Amateur Athletic Association (“AAU”). The peak performance service provider negotiates with the basketball league and/or the AAU to provide peak performance services to athletes, coaches, parents, and siblings of athletes in the basketball league. Once a service contract is in place, the peak performance services are provided to the athletes, coaches, parents, and siblings of the basketball league at reduced rates, or for free.

In yet another example, assume that the institution is a college. The college negotiates with the peak performance provider to provide peak performance services to athletes attending the college. An agreement is reached that the college will pay an annual fee to purchase the peak performance services. The peak performance service provider provides periodic (e.g., annual, bi-annual, semi-annual, or monthly) in-person visits to the campus of the college to gives courses and presentations on campus. The peak performance provider also provides periodic personal consultations with athletes of the college. The consultations can be in-person consultations, and/or telephonic/online consultations. In addition, the hard copy and electronic resources are provided to the college athletes for a reduced rate or for free.

In some embodiments, other family members of the college athletes can also receive peak performance services from the peak performance service provider for a reduced fee or for free. For example, if the college athlete has a younger sibling in high school, the sibling can obtain peak performance services (e.g., hard copy and electronic materials) for a reduced fee by virtue of the college athlete's association with the college. In yet another embodiment, the citizens of the city in which the college is located also qualify for reduced fee peak performance services from the peak performance service provider. Other configurations are possible.

One or more advantages are associated with the systems and methods for providing peak performance services disclosed herein. For example, by marketing to and allowing institutions to purchase peak performance services for individuals associated with the institutions, the institutions utilize their enhanced purchasing power to make peak performance services available to athletes, coaches, and parents whom otherwise could not afford to obtain such services. Also, more personalized services can be provided through consultations, courses, and seminars that are scheduled through the institution for the individuals associated with the institution. Further, the peak performance service provider can be structured such that service provider locations are located throughout a geographic area (e.g., through franchising) so that more personalized services can be provided. In this manner, peak performance services can be made available to a wider audience of individuals in an efficient and cost-effective way.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A system for providing peak performance services, the system comprising:
a peak performance service provider that provides peak performance services to enhance individuals' performances in sports; and
at least one institution that purchases peak performance services from the peak performance service provider for individuals associated with the institution;
wherein the peak performance provider makes the peak performance services available to the individuals associated with the institution for a reduced fee or for free; and
wherein the peak performance provider provides peak performance services to individuals not associated with the institution for regular fees.

2. The system of claim 1, wherein the peak performance service provider includes a plurality of individuals trained to provide the peak performance services.

3. The system of claim 2, wherein the peak performance service provider includes a plurality of sites located at geographically remote locations to provide the peak performance services.

4. The system of claim 1, wherein the peak performance services include access to resources about peak performance, and periodic personal consultations about peak performance.

5. The system of claim 1, wherein the institution is selected from the group consisting of high schools, colleges, and amateur athletic organizations.

6. The system of claim 1, wherein the individuals associated with the institution are athletes, coaches, administrators, or members of the athlete's nuclear family.

7. A method for providing peak performance services to enhance individuals' performances in sports, the method comprising:
marketing the peak performance services to institutions;
allowing an institution to purchase the peak performance services; and
providing the peak performance services to an individual associated with the institution.

8. The method of claim 7, further comprising allowing the individual to receive the peak performance services at a reduced rate or for free.

9. The method of claim 7, wherein the step of providing peak performance services further comprises providing access to resources about peak performance, and periodic personal consultations about peak performance.

10. The method of claim 7, wherein the step of marketing of the peak performance services further comprises marketing the peak performance services to schools.

11. The method of claim 7, wherein the step of marketing of the peak performance services further comprises marketing the peak performance services to institutions selected from the group consisting of high schools, colleges, and amateur athletic organizations.

12. The method of claim 7, further comprising allowing other members of the individual's family to purchase the peak performance services at a reduced rate or for free.

13. The method of claim 7, further comprising allowing individuals not associated with the institution to purchase the peak performance services at a regular rate.

14. The method of claim 7, further comprising selecting the individual associated with the institution to be athletes, coaches, administrators, or members of the athlete's nuclear family.

15. The method of claim 7, further comprising negotiating with one or more of the institutions to provide the peak performance services.

16. A method for providing peak performance services, the method comprising:
marketing peak performance services to a plurality of high schools;
negotiating with one or more of the high schools to provide the peak performance services to individuals associated with the high schools;
allowing a high school to purchase the peak performance services;
providing the peak performance services to individuals associated with the high school for free, the peak performance services including personal consultations, hard copy resources, and electronic resources; and
providing the peak performance services to family members of the individuals at a reduced rate.

17. The method of claim 16, further comprising selecting the individuals as athletes and coaches.

18. The method of claim 17, further comprising providing in-person consultations at the high school at periodic intervals.

19. The method of claim 16, further comprising providing in-person consultations at the high school at periodic intervals.

20. The method of claim 16, further comprising certifying a plurality of peak performance service providers to provide the peak performance services.
